(19) United States
(12) Patent Application Publication
(10) Pub. No.: US 2008/0114904 A1
(43) Pub. Date: May 15, 2008

(54) Sounding custom motor vehicle horntones

(76) Inventor: Michael Thomas Kosco, San Clemente, CA (US)

Correspondence Address: THOMAS J. KOSCO, 26521 MONTEBELLO PL., MISSION VIEJO, CA, 92691, US

(21) Appl. No.: 11/599,130

(22) Filed: Nov. 14, 2006

(51) Int. Cl. G06F 3/00; G06F 17/00; G06F 12/02

(52) U.S. Cl. 710/13; 700/94; 711/170; 711/E12.002

(57) ABSTRACT

This invention relates to the field of motor vehicle safety systems. Specifically, this invention creates a horntones audio player device, a new and useful method and a system that allows a user to sound custom motor vehicle horntones for alerting, locating and other purposes. The main elements of the system are a horntones audio player, a portable memory device and a remote computer. The player enables the user to sound custom horntones while the remote computer and the portable memory device operate together to both download new horntones files from a horntones website and transport the new horntones files to the horntones audio player.

### BACKGROUND OF THE INVENTION

The motor vehicle horn, as it is popularly known, of an automobile, truck, van, SUV, boat or other conveyance, is an ubiquitous method for providing an audible warning to nearby vehicles or pedestrians for perceived dangerous situations. This helps maintain a safe environment in the vicinity of the vehicle. Traditionally, the horn is a simple, single function electro-mechanical device that creates a loud, alerting sound when the horn button is pushed, usually from within the vehicle. This horn sound does not differentiate between the types of situations that would require its sounding, nor does the horn provide for other beneficial uses of its sounding.

### BRIEF SUMMARY OF THE INVENTION

The invention expands the capabilities of the motor vehicle horn beyond that just described to include providing a menu of selectable sounds, called horntones, that can be sounded for various safety, communication and other purposes. Examples of possible horntones include conventional horn sounds, sounds having custom audio spectral content, sounds having different loudness levels, voice messaging sounds and musical sounds.

One aspect of the invention provides a horntones audio player device and that allows a user to sound a variety of personalized motor vehicle horntones while operating an automobile or other motor vehicle conveyance. The horntones audio player is the heart of the system and is located in an easily accessible position within the vehicle. The audio player is a microprocessor-based set of electronics, amplifier(s) and speakers that enable a custom horntone audio file to be “played” whenever a button is pressed. This button can be one of a set of “presets” on the audio player panel, on the steering wheel or it can be the motor vehicle horn button itself.

Another aspect of the invention provides a unique and novel method for incorporating additional horntones into the audio player. A portable memory device (e.g. USB Flash drive) is utilized to transport horntones from a remote computer to the vehicle's horntones audio player. The portable memory device is “registered” as a horntones transport by simply plugging it into a horntones audio player. The process of registration defines a unique area on the portable memory device that both the horntones audio player and software running on a remote computer recognize. This unique area on the portable memory device is used for communications between that horntones audio player and software running on a remote computer. Subsequent to registration, the portable memory device is connected to a remote computer that, in turn, accesses a website providing horntones (i.e. horntones.com) or other source of horntone files. There, horntones may be previewed, selected, licensed and downloaded to the portable memory device for transport to the horntones audio player. After the horntone files are downloaded to the portable memory device, the portable memory device is transported to and plugged into the associated horntones audio player where the horntones are transferred into the player.

An initial default set of horntones is factory-programmed into every horntones audio player. This allows the user to use the player “out of the box”. A user can add custom horntones to the default set in two ways. First, horntones may be added by accessing a horntones website or other source of horntones files and selecting horntones and downloading the new horntones to a portable memory device and then plugging the portable memory device into the associated horntones audio player where the horntones are transferred into the player. Second, horntones can be added by creating user-authored horntone audio files (e.g. MP3 file) on a local computer and transferring the user-authored horntone audio files to a portable memory device and then connecting the portable memory device to the associated horntones audio player where the horntones are transferred into the player. The newly loaded horntones are then added to the list of onboard horntones available for play by the horntones audio player. Optionally, user-authored horntones may require licensing. Licensing is accomplished by submitting the user-authored horntones file to the horntones website or other software capable of performing horntones file licensing. Horntones licensing is achieved through use of proprietary horntones encryption mechanisms and authorization processes. Licensing of user-authored horntones can protect the user from unauthorized use by others of his or her personally authored horntones.

### BRIEF DESCRIPTION OF THE DRAWINGS

The objects, features and advantages of the system of the invention will be apparent from the following description in which:

FIG. 1 illustrates the major components of the horntones system which enable custom horntones to be played on motor vehicles or other conveyances.

FIG. 2 is a block diagram of the major elements of the horntones audio player and their functional and physical interrelationships.

FIG. 3 is a flow diagram that illustrates the operation of the portable memory, horntones transport device (e.g. USB flash drive) with the horntones audio player.

FIG. 4 is a flow diagram that illustrates the generalized operation of the horntones audio player.

### NOTATIONS AND NOMENCLATURE

The following definitions are meant for guidance, but in no way to limit the claimed invention or meanings of terms.

Applet—a small, stand alone software program that performs a special function, usually from within a larger software program.

Bus, System—the primary communications pathway for information flowing between a central processing unit, memory and peripherals.

Client computer—a computer serving end users and running user application programs.

Client—a user; a user of a client computer.

Computer—a device that performs digital processing; provides digital storage and has input/output capability; includes items such as personal computers (PC), personal digital assistants (PDA), server computers, cell phones, and the like.

Computer, Web-based—a computer having the capability to access the internet and the World Wide Web.

Download—To copy or move an electronic file from a computer, disk or other storage medium onto another.

Graphical User Interface (GUI)—a user interface that allows a user to interact with a computer display by pointing at selectable control areas on the display and activating a command or computer operation associated with the selectable control area; GUIs are well known in the art.

Horntones—audio files containing sounds (monotonic or complex tones, voice, music or any other audible material) that can be played in a vehicle horntones player and that augment or replace the motor vehicle horn function. Horntone audio file format may be proprietary or any standard audio file formats such as, but not limited to: MP3, WAV, WMA, OGG or ADPCM.

Horntones Website—a site (location) on the World Wide Web where horntones are available.

Internet—the worldwide, publicly accessible network of interconnected computer networks that transmit data by packet switching using the standard Internet Protocol (IP). It is a “network of networks” that consists of millions of smaller domestic, academic, business, and government networks, which together carry various information and services, such as electronic mail, online chat, file transfer, and the interlinked Web pages (Websites) and other documents of the World Wide Web.

License—an authorization to use.

Licensing—for horntones applications, licensing is the process of encrypting each horntone that permits it to be played on a single horntones player.

Motor Vehicle—any vehicle used to transport people, such as an automobile, truck, van, SUV, boat, for example.

Mount—verb, the process of making a storage device (such as a hard drive, CD-ROM, or network share) accessible to a computer operating system. You can only access files on mounted media.

“out of the box”—a term used to indicate that an item can be used as received, without any special initialization actions.

Register—verb, to formally identify and add to a list or database.

Registering—for horntones applications, registering is the process of enabling a portable memory device to carry horntones for a given horntones player. The process of registration defines a unique area on the portable memory device which is recognized by both the horntones audio player and software running on a remote computer. This unique area is used for communicating between the horntones audio player and software running on a remote computer.

Theme, Horntones—a horntones theme is a name assigned to a set of horntones having the same character of audio sounds (ex, traffic, carpool, tailgate party, etc.).

User—a person who uses the horntones system.

Window—an area, usually rectangular, on a computer display screen controlled by an application.

World Wide Web—information available on the Internet that can be easily accessed with software called a “browser.”

### DETAILED DESCRIPTION OF THE INVENTION

The invention is directed to an electronic player device, a method, and a system that allows a user to select and play a variety of custom motor vehicle horntones.

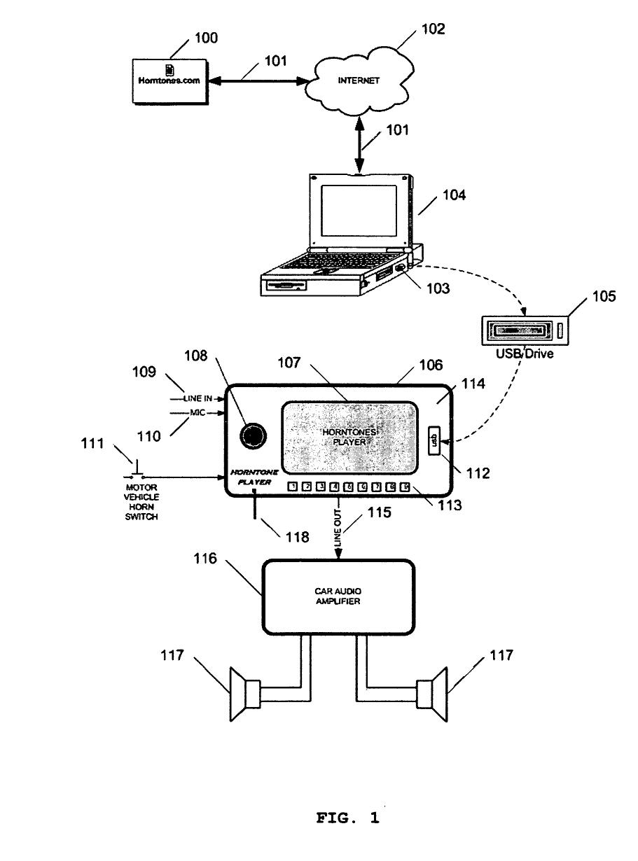

Some elements of a horntones system are shown in FIG. 1 wherein a horntones audio player 106 provides the primary user interface in playing and configuring of horntones. An antenna 118 or other wireless means of communications can be used to transfer horntones files from a remote horntones source to the horntones audio player. A portable memory device (e.g. USB Flash drive) 105 facilitates the transfer of horntones files between a remote computer 104 and the horntones audio player 106. The remote computer 104 is used to connect to the horntones website 100, or other source of horntone files, utilizing the Internet 102 and internet communication links 101. The remote computer 104 also provides the means to browse the horntones website 100 or other source of horntones files, optionally license new horntone files and download horntone files 101 to the portable memory device 105 connected to the connecting mechanism 103 on the remote computer 104.

The portable memory device 105 is initialized by momentarily connecting it into a horntones audio player connecting mechanism 112. This registers the portable memory device 105, enabling it to transport new horntones files for that horntones audio player 106. An additional capability is provided to enable a single portable memory device 105 to be registered to multiple horntones audio players 106.

The horntones audio player 106 is the primary user interface. It is a compact electronic unit located in an easily accessible position within the vehicle. It has a front panel 114 containing a graphic display 107, several mechanical switches and a connecting mechanism 112. The mechanical switches include a multi-function controller button 108 for controlling power, horntones volume, horntones equalization and selection from among the library of internally-stored horntones, plus a set of pushbuttons 113 for presetting individual horntones. The graphic display 107 provides a visual indication of player status.

The horntones audio player 106 also provides inputs for a motor vehicle horn switch 111 that can be used to sound a horntone, an audio line input 109 and a microphone input 110 that can be used to record additional horntones. A stereo line out 115 is provided to drive a remote audio amplifier 116 and audio speakers 117 to the desired audio sound level.

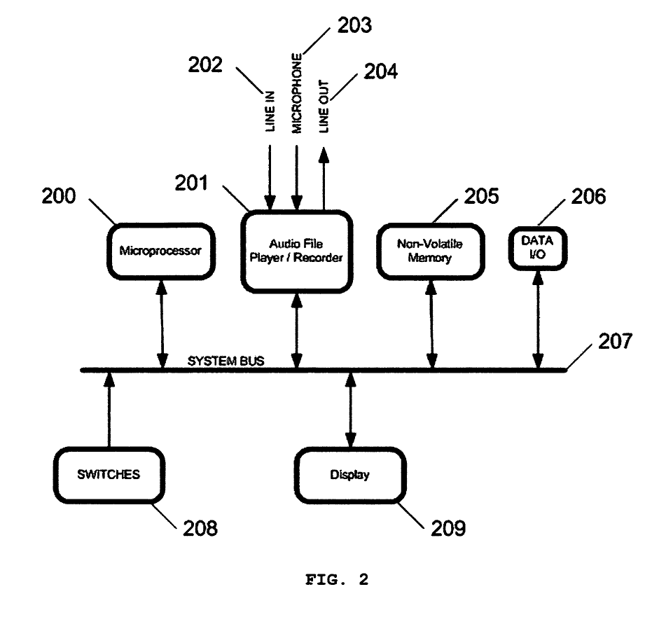

The architecture of the horntones audio player 106 is illustrated in FIG. 2. It utilizes a system bus 207 approach that enables a modular, flexible design. A microprocessor 200 executes a program residing in a non-volatile memory 205 to control horntones operations as well as manage a data input/output interface 206. Horntones are also stored in a non-volatile memory 205. The horntones audio player 106 has a group of switches 208 and a display device 209 on the front panel to provide an operational user interface. The horntones audio player 106 incorporates an audio file player/recorder 201 that accommodates an audio line input 202, a microphone input 203 as well as an audio line output 204.

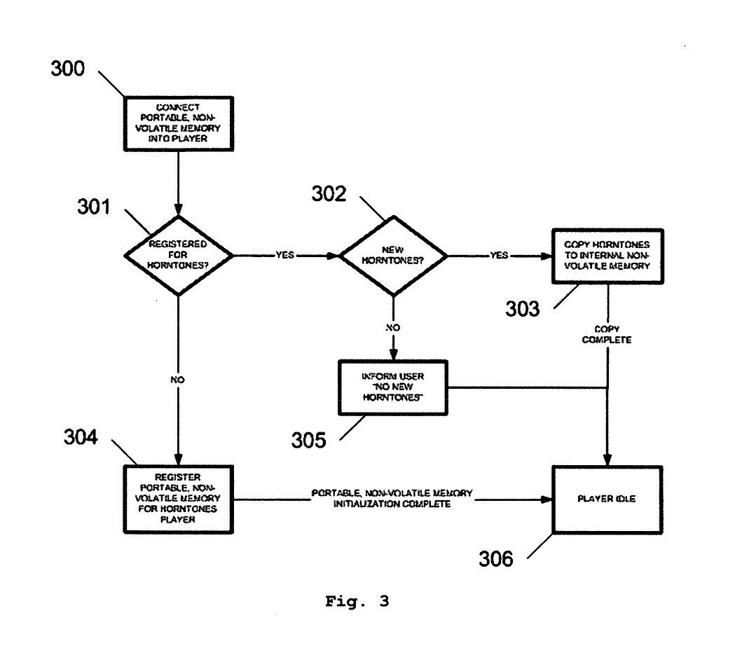

The operation of the portable memory device 105 (e.g. USB Flash drive) with the horntones audio player 106 is shown in FIG. 3. The portable memory device 105 has two modes of interaction with the horntones audio player 106. The first mode is initialization (or registration) and the second mode is downloading of horntones files from the non-volatile memory device 105 into the horntones player's 106 non-volatile memory 205. Whenever a portable memory device 105 is connected to the horntones audio player (300), its registration status is first checked (301). If it has not been registered, it is registered (304), whereby a unique area on the non-volatile memory device is defined for communications with a remote computer. This completes the initialization process. The horntones audio player 106 then transitions to idle state 306 and the portable memory device 105 may be removed. If the portable memory device 105 is already registered when plugged into the horntones player 106, it is checked for new horntones files (302). If new horntones files are found, those horntones files are downloaded (303) to the horntones player's non-volatile memory 205, a “copy complete” message appears on the display 107, and the horntones audio player 106 transitions to idle state (306). If no new horntones files are found, a “no new horntones” message (305) is shown on the horntones player's display 107 and the horntones player 106 transitions to idle state (306).

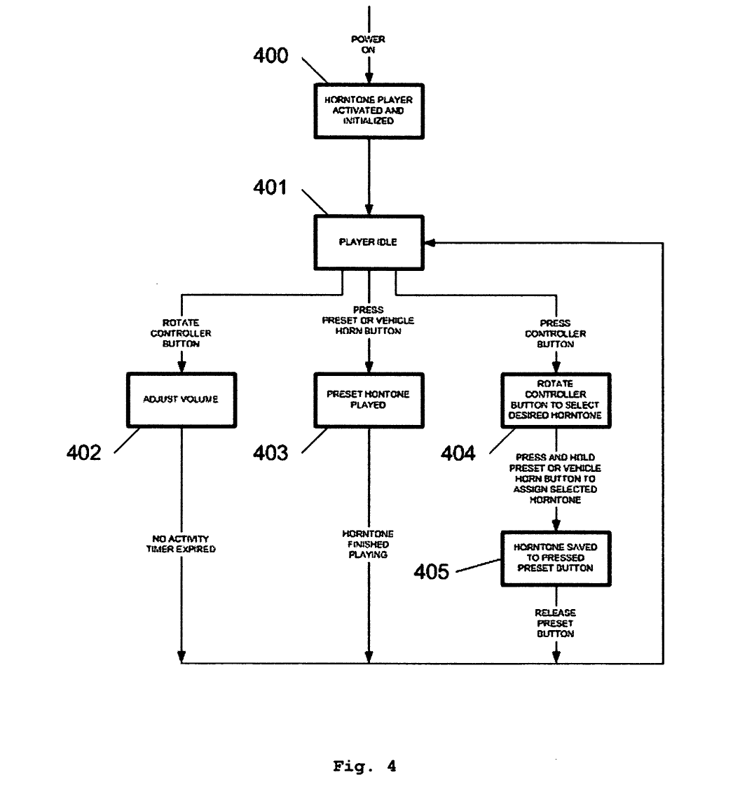

The generalized operation of the horntones audio player 106 is illustrated in FIG. 4. The horntones player is activated and initialized (400) by applying power to the horntones audio player. The horntones audio player 106 then transitions to idle state (401). The user may now adjust the audio volume (402), play a preset horntone (403), or select (404) and assign (405) one or more horntones to the preset buttons 113 or the vehicle horn button 111. To adjust the audio volume, the controller button is rotated to obtain the desired volume (402). After a few seconds of no activity, the horntones audio player 106 transitions to idle state (401). To play a preset horntone, the user pushes a preset button 113 or the vehicle horn button 111 and the horntone is played (403). When the horntone is ended, or the preset button 113 released, the horntones player 106 transitions to idle state (401). To assign a different horntone to a preset button 113 or the vehicle horn button 111, the controller button 108 is momentarily pressed and released and then rotated (404) to highlight one from among the horntones listed on the display 107. When the desired horntone is highlighted, the corresponding preset button 113, or the vehicle horn button 111, is pushed and held for a few seconds and the horntone is saved to that preset button (405). The controller button 108 is then released and the horntones audio player 106 enters idle state (401).

While the invention has been particularly described with reference to an example embodiment, it should be readily apparent to those skilled in the art that changes and modifications in form and details may be made without departing from the spirit and scope of the invention. Accordingly, the scope of the invention should be determined not by the embodiment illustrated but by the appended claims and their legal equivalents.

What I claim as my invention is:

1. A device for sounding motor vehicle horntones, the device comprising:
a horntones audio player located within a motor vehicle adapted to play horntone files stored within said horntones audio player when a motor vehicle horn button is pushed;
a user panel on said horntones audio player capable of playing said horntone files by pushing at least one from a group of buttons located on said user panel; and
a connecting means for connecting said horntones audio player to a portable memory device to load said horntone files into said horntones audio player.

2. The device of claim 1, wherein said connecting means comprises a connector, antenna, or wireless connection.

3. The device of claim 1, wherein said memory device comprises a USB flash drive.

4. The device of claim 1, further comprising a microprocessor configured to automatically register said memory device when said memory device is connected to said horntones audio player.

5. The device of claim 1, wherein said horntones audio player comprises:
a system bus;
a non-volatile memory coupled to said system bus and storing a plurality of different horntones;
a microprocessor coupled to said system bus;
an audio file player/recorder coupled to said system bus;
a display coupled to said system bus;
a plurality of switches; and
an input/output port.

6. A method for using different horntones on a motor vehicle, the method comprising:
storing a plurality of different horntones on a portable memory;
connecting said memory to an audio player coupled to horn speakers on said motor vehicle;
transferring said different horntones to said audio player;
selecting a specific one of said different horntones to use; and
depressing a horn button to play said specific horntone.

7. The method of claim 6, wherein said memory is a non-volatile memory device.

8. The method of claim 6, wherein said storing comprises connecting said memory to a computer.

9. The method of claim 8, wherein said computer accesses said different horntones from the Internet or a file.

10. The method of claim 6, further comprising registering said portable memory upon said connecting.

11. The method of claim 6, further comprising removing said memory from said audio player after said transferring is completed.

12. The method of claim 6, wherein said selecting comprises pressing a specific button on said audio player.

13. The method of claim 6, wherein said selecting comprises rotating a knob to store a specific horntone corresponding to a specific button on said audio player and pressing said specific button.

14. The method of claim 10, further comprising assigning a unique registration area to said memory corresponding to said audio player.

15. The method of claim 14, wherein said memory is usable with different audio players.

16. The method of claim 6, wherein said memory is a USB flash drive.

17. A system for sounding motor vehicle horntones, the system comprising:
a horntones audio player located within a motor vehicle for playing horntone audio files;
a remote computer for browsing, selecting and downloading said horntone audio files from a source of horntone audio files;
a portable memory device for transporting said horntone audio files from a said computer to said player.

18. The system of claim 17, wherein said source of horntone audio files is a website.

19. The system of claim 17, wherein said source of horntones audio files is an electronic storage medium.

20. The system of claim 17, wherein said portable memory device is a USB flash drive.
